(19) United States
(12) Patent Application Publication
(10) Pub. No.: US 2009/0155675 A1
(43) Pub. Date: Jun. 18, 2009

(54) BATTERY MODULE

(75) Inventor: Gary P. Houchin-Miller, Milwaukee, WI (US)

Correspondence Address: FOLEY & LARDNER LLP, 777 EAST WISCONSIN AVENUE, MILWAUKEE, WI, 53202-5306, US

(73) Assignee: Johnson Controls - SAFT Advanced Power Solutions LLC

(21) Appl. No.: 12/371,884

(22) Filed: Feb. 16, 2009

Related U.S. Application Data
(63) Continuation of application No. PCT/US2007/018855, filed on Aug. 28, 2007.
(60) Provisional application No. 60/840,795, filed on Aug. 29, 2006.

(51) Int. Cl. H01M 6/42

(52) U.S. Cl. 429/120

(57) ABSTRACT

A battery module includes a housing having a central plenum and a plurality of cells provided within the housing, the plurality of cells including a first group of cells and a second group of cells separated from the first group by the central plenum. The housing is configured to direct cooling air from the central plenum to the plurality of cells and each of the first group and the second group is arranged in a first layer of cells and a second layer of cells offset relative to the first layer of cells.

### CROSS-REFERENCE TO RELATED PATENT APPLICATIONS

This application is a Continuation of International Application No. PCT/US2007/018855, filed Aug. 28, 2007, which claims the benefit of U.S. Provisional Application No. 60/840,795, filed Aug. 29, 2006. The disclosures of International Application No. PCT/US2007/018855 and U.S. Provisional Application No. 60/840,795 are incorporated herein by reference in their entireties.

### BACKGROUND

The present invention relates generally to the field of batteries and battery systems or modules. More specifically, the present invention relates to a system for packaging, connecting, and regulating a plurality of batteries provided in a battery module (e.g., in a cell assembly or module).

It is known to provide batteries for use in vehicles such as automobiles. For example, lead-acid batteries have been used in starting, lighting, and ignition applications. More recently, hybrid electric vehicles are being developed which utilize a battery (e.g., a nickel-metal-hydride battery) in combination with other systems (e.g., an internal combustion engine) to provide power for the vehicle.

It is known that batteries or cells generally produce heat when they convert chemical energy to electrical energy. In certain situations, the temperature of the batteries may rise. It would be desirable to provide an improved system that removes the heat produced by the batteries and manages the temperatures of the batteries in a battery module.

### SUMMARY

One embodiment relates to a battery module comprising a housing comprising a central plenum and a plurality of cells provided within the housing, the plurality of cells comprising a first group of the plurality of cells and a second group of the plurality of cells separated from the first group by the central plenum. The housing is configured to direct cooling air from the central plenum to the plurality of cells and each of the first group and the second group is arranged in a first layer of cells and a second layer of cells offset relative to the first layer of cells.

Another embodiment relates a battery module that includes a housing and a plurality of electrochemical cells provided within the housing. The plurality of cells includes a first group of cells and a second group of cells, wherein the first group and the second group each comprise a first layer of cells and a second layer of cells, with the second layer of cells offset relative to the first layer of cells. The housing includes a space between the first group and second group for routing cooling air and the housing is configured to direct cooling air from the space to the plurality of cells.

Another embodiment relates to a battery module comprising a housing comprising a first member and a second member that are arranged to define a central plenum, and a third member provided between the first member and the second member, wherein the first member, the second member, and the third member are arranged to define a plurality of cell plenums in communication with the central plenum. The plurality of cell plenums comprises a first group of cell plenums separated from a second group of cell plenums by the central plenum. Each of the first group of cell plenums and the second group of cell plenums comprises a first layer of cell plenums and a second set of cell plenums offset relative to the first layer of cell plenums.

### BRIEF DESCRIPTION OF THE FIGURES

FIG. 1 is a perspective view of a vehicle having a battery module according to an exemplary embodiment.

FIG. 2 is a perspective view of a battery module according to an exemplary embodiment.

FIG. 3 is an exploded perspective view of the battery module shown in FIG. 2 according to an exemplary embodiment.

FIG. 4 is an exploded side view of the battery module shown in FIG. 2 according to an exemplary embodiment.

FIGS. 5-8 are perspective views of various portions of the battery module shown in FIG. 2 according to various exemplary embodiments.

FIG. 9 is a cross-sectional perspective view of the battery module shown in FIG. 2 taken along line 9-9 according to an exemplary embodiment.

FIG. 10 is a cross-sectional perspective view of the battery module shown in FIG. 2 taken along line 10-10 according to an exemplary embodiment.

### DETAILED DESCRIPTION

Existing battery systems utilizing a large number of batteries or cells may be provided such that cells included in the system are not optimally arranged (e.g., the overall volume of the system is greater than in an optimal arrangement, electrical connections may be relatively difficult to access, etc.). According to an exemplary embodiment, the battery module shown in FIGS. 2-10 provides an improved arrangement of cells (e.g., the cells are packed more closely to reduce volume of the system) in which terminals and wiring for each of the cells may be arranged toward the exterior of the battery module. This provides the ability to more efficiently assemble the battery module (e.g., wires are more accessible to the assembler, etc.). This also decreases the overall height of the battery module. This is desirable for placement in a vehicle, where space constraints may dictate the overall size of the battery module.

Furthermore, the battery module shown in FIGS. 2-10 facilitates the removal of heat from batteries. The heat may be removed by conduction or convection to allow the batteries to continue to function normally. For example, a fan may be used to blow a gas (e.g., cooling air, etc.) over the batteries to remove heat. The amount of heat exchanged between the battery and the cooling air is dependent upon many variables, one of which is the difference in temperature between the battery and the cooling air. The battery module illustrated in FIGS. 2-10 increases the effectiveness of the cooling air by directing it first to a central plenum area, and then into individual cell plenums and over individual cells before it is exhausted.

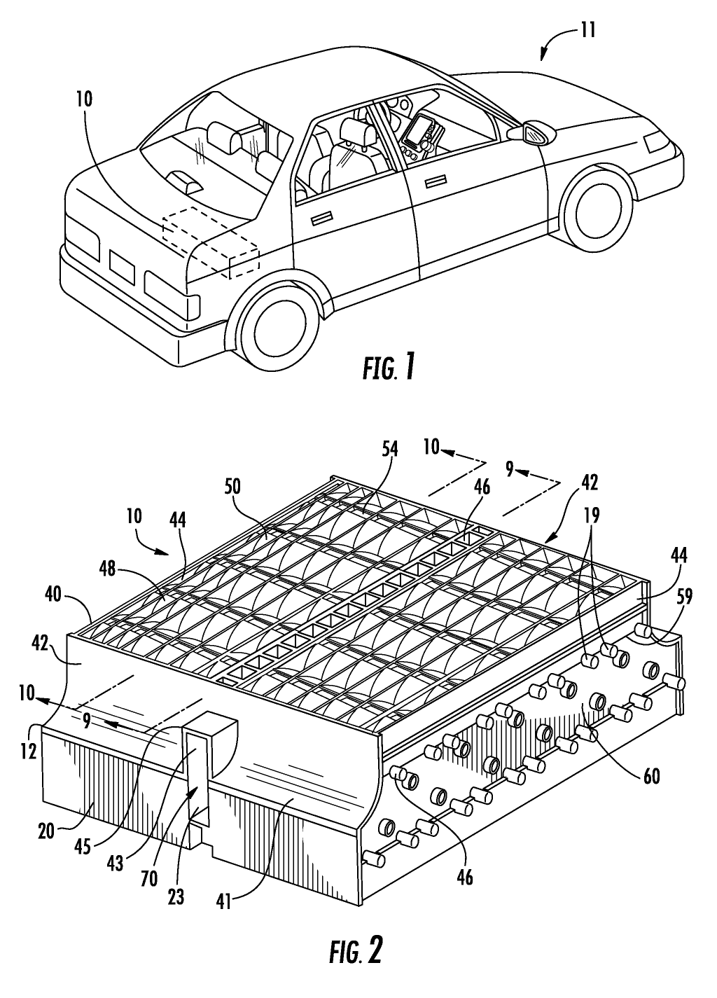

Referring now to FIG. 1, a vehicle 11 is shown according to an exemplary embodiment and includes a battery system or battery module 10. The size, shape, configuration, and location of battery module 10 and the type of vehicle 11 may vary according to various other exemplary embodiments. For example, while vehicle 11 in FIG. 1 is shown as an automobile, according to various exemplary embodiments, vehicle 11 may comprise a wide variety of differing types of vehicles including, among others, motorcycles, buses, recreational vehicles, boats, and the like. According to an exemplary embodiment, vehicle 11 is a hybrid electric or electric vehicle.

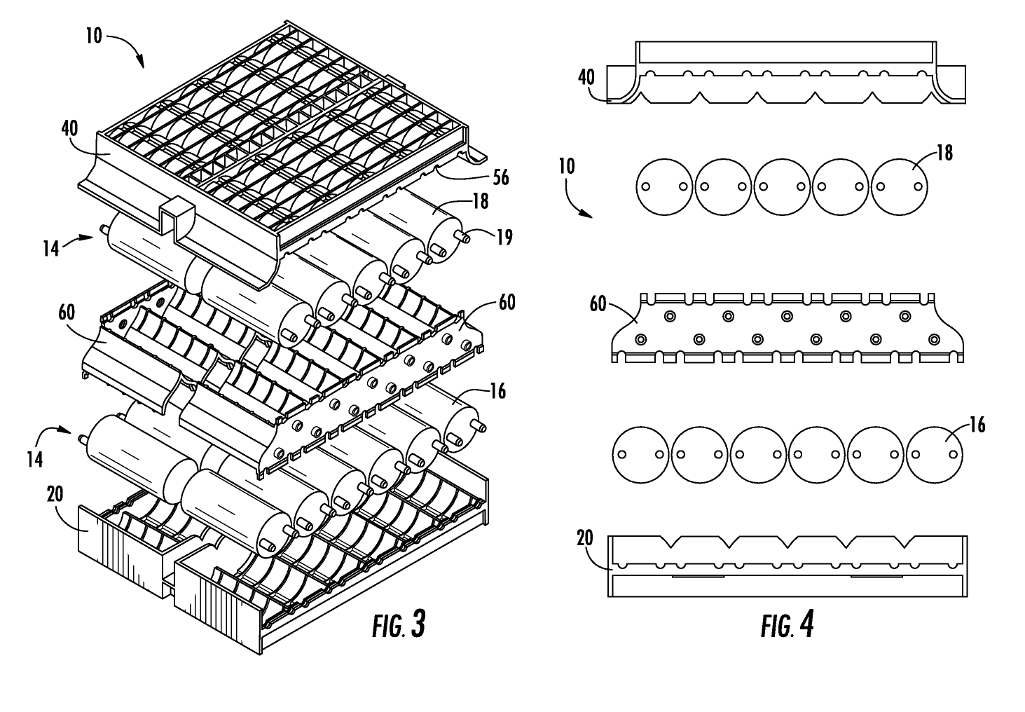

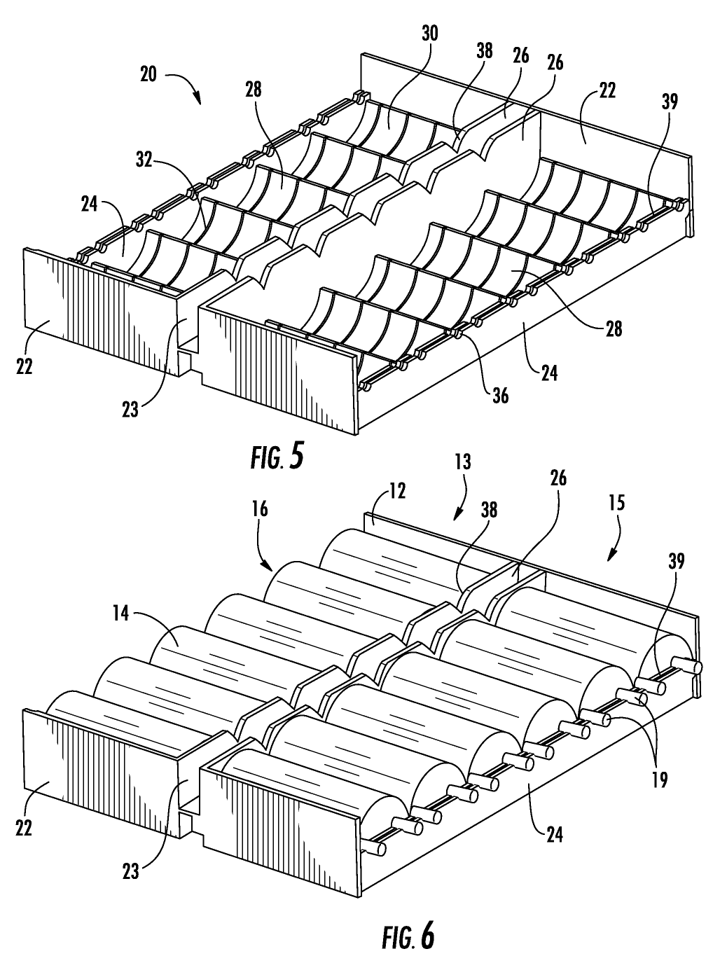

Referring to the FIGS. 2-8, battery module 10 is shown in greater detail according to an exemplary embodiment. Battery module 10 comprises a housing or casing 12 within which electrochemical cells 14 are provided. Cells 14 include a first group 13 and a second group 15 of electrochemical cells 14. Groups 13 and 15 are separated by a plenum 70, but are otherwise arranged substantially end-to-end with each other (see, e.g., FIGS. 6 and 8). Cells 14 are further arranged in a first layer 16 and a second layer 18, as shown in FIGS. 3 and 4. First layer 16 and second layer 18 are arranged such that layers 16, 18 are offset relative to each other when housed within module 10. According to an exemplary embodiment, cells 14 are lithium-ion batteries, although those reviewing this disclosure will recognize that other types of batteries may also be used (e.g., nickel-metal-hydride batteries, lithium-polymer batteries, etc.).

According to an exemplary embodiment as shown in FIGS. 2-3, housing 12 comprises a lower member or element 20 (e.g., tray, bottom, lower container, lower enclosure, first tray, etc.) and an upper member or element 40 (e.g., tray, top, upper container, upper enclosure, second tray, etc.) that substantially enclose cells 14, and two intermediate members or elements 60 (e.g. separators, insulators, dividers, third trays, etc.) that separate first layer 16 from a second layer 18 (as best shown in FIGS. 3-4). Housing 12 (e.g., members 20, 40, and 60) is a generally non-conductive body that is configured to hold and arrange cells 14. According to an exemplary embodiment, housing 12 may be made from any suitable material such as a polymeric material (e.g., polypropylene, polyethylene, etc.).

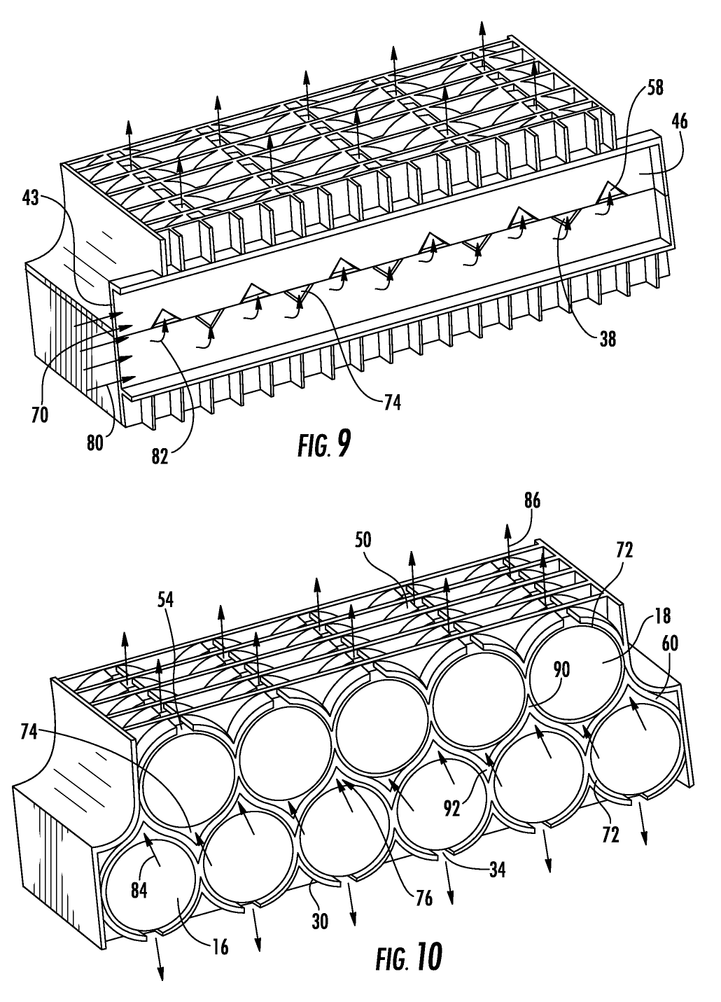

Referring to FIGS. 5 and 6, lower member 20 is shown in greater detail according to an exemplary embodiment. Lower member 20 comprises two end walls 22, two side walls 24, two inner walls 26, and a support member 28. End walls 22, side walls 24, and support member 28 form a generally open-topped structure. Inner walls 26 are generally parallel to side walls 24 and are disposed toward the middle of lower member 20. One end wall 22 includes an opening 23 (e.g., inlet, aperture, hole, cutout, etc.), that along with inner walls 26, forms a portion of a manifold or central plenum air space 70 (see, e.g., FIGS. 2 and 9) as discussed in greater detail below.

Support member 28 is provided on either side of central plenum 70 and comprises a series of generally semi-cylindrical depressions 30 (e.g., troughs, beds, cradles, etc.) that are configured to receive a first layer 16 of cells 14 between inner walls 26 and side walls 24. As shown in FIG. 5, a plurality of ribs 32 (e.g., ridges, protrusions, stand-offs, etc.) are provided along depressions 30 and are configured to form air spaces 72 (see FIG. 10) between cells 14 and support member 28. As shown in FIG. 10, depressions 30 further include a plurality of openings 34 (e.g., outlets, apertures, holes, slots etc.) that are configured to allow cooling air to exit housing 12.

According to an exemplary embodiment, cells 14 comprise two terminals 19 (e.g., one positive terminal and one negative terminal). Side walls 24 comprise a plurality of features 36 (e.g., notches, cutouts, contours, etc.) that are configured to receive terminals 19 and allow terminals 19 to extend outward past side walls 24. According to an exemplary embodiment, slots 39 are provided on side walls 24 and are configured to receive members 60. Cells 14 are arranged such that terminals 19 are located toward the exterior of battery module 10. This arrangement allows all connections between cells 14 and other cells 14, or other components (e.g., a battery management system, etc.) to be made to the exterior of battery module 10 and allows battery housing 12 to be assembled before any connections to cells 14 are made.

According to an exemplary embodiment, inner walls 26 comprise a plurality of openings 38 (e.g., notches, cuts, contours, etc.). Openings 38 are generally aligned with the spaces between cells 14, and are configured to allow air to flow from central plenum 70 and across cells 14 as shown and discussed in greater detail with respect to FIGS. 9 and 10.

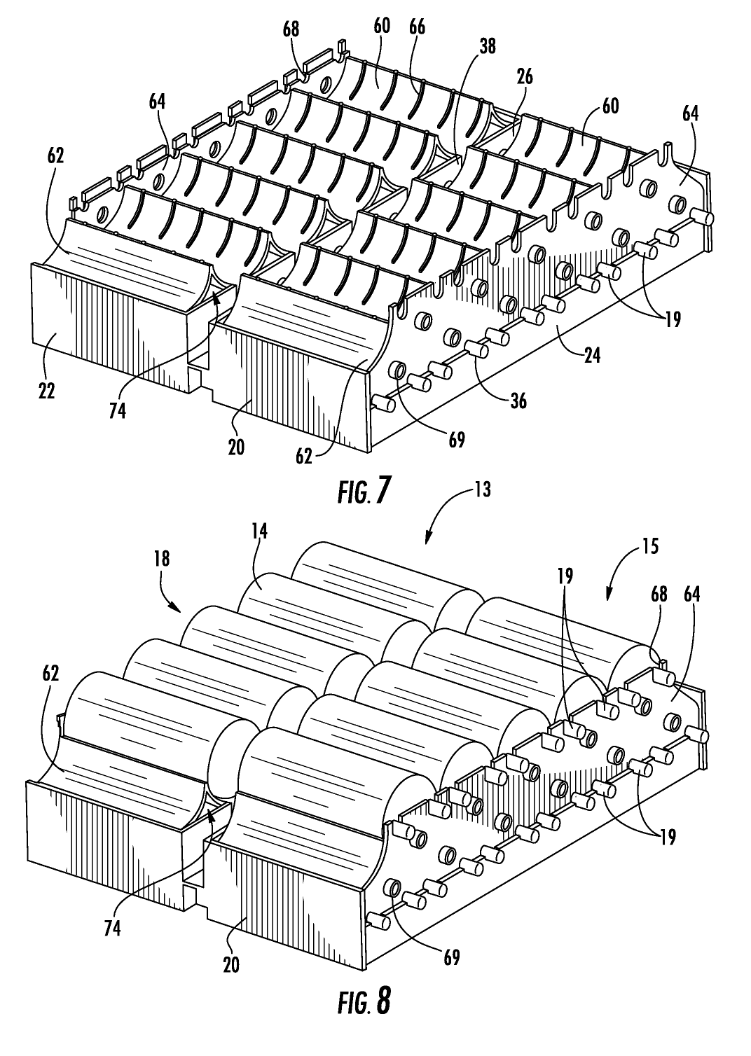

Referring now to FIG. 7, members 60 are shown placed over first layer 16 of cells 14. Two members 60, each comprising a main body 62 and an end plate 64, are provided, one on either side of central plenum 70. Main body 62 is a generally thin-walled structure that is provided to allow arrangement of first layer 16 and second layer 18 in a staggered or offset manner. Members 60 electrically insulate first layer 16 and second layer 18 from each other. As shown in FIGS. 3 and 8, main body 62 is configured to receive first layer 16 and second layer 18 such that second layer 18 is offset with respect to first layer 16 to efficiently pack cells 14 in battery module 10.

Referring further to FIG. 7, according to an exemplary embodiment, main body 62 includes a plurality of ribs 66 (e.g., ridges, protrusions, stand-offs, etc.) on the surface of main body 62 that are configured to form air spaces 72 (see FIG. 10) between cells 14 and members 60. As shown in FIG. 7, ribs 66 are provided on the surface of main body 66 that engages or supports layer 18 of cells 14. According to another exemplary embodiment, ribs 66 may be provided on both surfaces of main body 62. As shown in FIG. 10, main body 62 includes portions 92 that extend between the individual cells 14 of first layer 16 to define cell plenums 74 for second layer 18, and portions 90 that extend between the individual cells 14 of second layer 18 to define cell plenums 76 for first layer 16. Members 60 cooperate with indentations 38 to direct air from central plenum 70 to cell plenums 74, 76.

According to an exemplary embodiment, end plate 64 of member 60 is generally perpendicular to main body 62 and parallel to side wall 24 of lower member 20. End plate 64 fits into slot 39 in side wall 24 and comprises a plurality of indentations 68. Indentations 68 cooperate with indentations 36 on side wall 24 to substantially surround terminals 19. End plate 64 may further comprise apertures 69 that are configured to receive sensors (e.g., temperature sensors, etc.).

Referring to FIG. 8, second layer 18 of cells 14 is shown. Cells 14 in second layer 18 are received by members 60 and are generally offset from cells 14 in first layer 16 in a natural cylindrical packing arrangement to relatively efficiently pack cells 14 (e.g., by taking advantage of the spaces left between adjacent cells 14 due to the cylindrical shape of cells 14 (see, e.g., FIG. 10)). Terminals 19 of cells 14 are received by indentations 68 on end plates 64. Because of the offset configuration of cells 14 (e.g., because cells 14 in layer 18 are not positioned directly above corresponding cells 14 in layer 16, but are received in the space formed between adjacent cells 14), the overall height of layer 16 positioned above or adjacent layer 18 is minimized. This provides an advantage over other packaging configurations (e.g., such as a traditional six-pack configuration where the cells would be aligned such that cells in different layers would be positioned directly above corresponding cells in adjacent layers), where the overall height of layer 16 positioned over layer 18 would be the full height of first layer 16 and the full height of second layer 18 and any intermediate space between them.

Referring now back to FIG. 2, battery module 10 is shown with upper member 40 provided. Upper member 40 comprises two end walls 42, two side walls 44, two inner walls 46, and an upper surface 48. End walls 42, side walls 44, and upper surface 48 form a structure that is configured for coupling to lower member 20 and end plates 64 of members 60 to substantially enclose cells 14. Lower member 20 and upper member 40 may include features (e.g., pins, nubs, ridges, guides, etc.) (not shown) that are configured to properly align lower member 20 with upper member 40. Because of the offset arrangement of cells 14, end walls 42 of upper member 40 may be offset from end walls 22 of lower member 20 and upper member 40 may comprise flanges 41 that extend outward from end walls 42. One end wall 42 comprises an opening 43 (e.g., inlet, aperture, hole, etc.) that cooperates with inner walls 46 to form a portion of central plenum 70. Upper member 40 may further comprise a shroud 45 that substantially surrounds opening 43.

Upper member 40 is arranged facing lower member 20 in battery module 10 (see, e.g., FIGS. 3 and 4). Member 40 includes a series of depressions 50 (e.g., troughs, beds, cradles, etc.) that are configured to receive second layer 18 of cells 14 between inner walls 46 and side walls 44 (e.g., in an abutting relationship). A plurality of ribs (not shown) (e.g., ridges, protrusions, stand-offs, etc.) similar to those shown in FIG. 5 as ribs 32 are provided along depressions 50 and are configured to form air spaces 72 (see FIG. 10) between cells 14 and upper surface 48. Depressions 50 further include a plurality of openings 54 (e.g., outlets, apertures, holes, slots etc.) that are configured to allow cooling air to exit housing 12.

Side walls 44 comprise a plurality of indentations 56 (see FIG. 3) (e.g., notches, cuts, contours, etc.) that are configured to receive terminals 19 and allow terminals 19 to extend outward past side walls 44. According to an exemplary embodiment, each side wall 44 includes a slot 59 that is configured to receive members 60. As best shown in FIG. 5, inner walls 46 comprise a plurality of openings 58 (e.g., notches, cuts, contours, etc.). Openings 58 are generally aligned with the spaces between cells 14, and are configured to allow air to flow from central plenum 70 to cell plenums 74, 76.

Referring now to FIGS. 9 and 10, the path of cooling air through module 10 is shown according to an exemplary embodiment. The cooling air enters through openings 23, 43 and flows to central plenum 70. From central plenum 70, the cooling air flows through openings 38, 58 and into cell plenums 74, 76 provided on either side of central plenum 70. The cooling air flows over cells 14 within cell plenums 74, 76 and exits module 10 through openings 34, 54. According to an exemplary embodiment, the cooling air flows past cells 14 in a cross-flow fashion (e.g., in a direction generally transverse to the longitudinal axis of the cells 14). According to another exemplary embodiment, the various cell plenums 74, 76 may be in fluid communication with each other such that the cooling air may flow, e.g., directly from one cell plenum 74 to an adjacent cell plenum 76.

The embodiment illustrated in FIG. 9 may provide a number of advantages. For example, the arrangement of cells 14 may allow for more efficient air cooling. The size of spaces 72 and cell plenums 74, 76 are optimized due to the relatively efficient packing of cells 14 (e.g., due to the offset configuration of layers 16, 18). Furthermore, the cooling air is kept closer to cells 14 by cell plenums 74, 76 in this arrangement (e.g., in contrast to configurations where individual cells plenums are not utilized) and accordingly removes heat more efficiently as opposed to a configuration where a large amount of air flows further away from the cells, which does not efficiently remove heat from the surface of the cell.

Although the exemplary embodiments illustrate a battery module for generally cylindrical batteries, it should be recognized by those skilled in the art that the battery module may be used with other battery configurations (e.g., generally oval batteries, prismatic batteries, etc.).

It should be noted that references to “front,” “back,” “upper,” and “lower” in this description are merely used to identify various elements as they are oriented in the FIGURES, with “front” and “back” being relative to the vehicle in which the battery module is placed.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is important to note that the construction and arrangement of the battery module as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter. For example, elements shown as integrally formed may be constructed of multiple parts or elements (e.g., upper and lower trays, members, etc.), the position of elements may be reversed or otherwise varied (e.g., orientation of cells), and the nature or number of discrete elements or positions may be altered or varied (e.g., more or fewer cells could be used, depending on the needs and/or space constraints of different vehicles). Accordingly, all such modifications are intended to be included within the scope of the present disclosure. The order or sequence of any process or method steps may be varied or re-sequenced according to other exemplary embodiments. Other substitutions, modifications, changes and omissions may be made in the design, operating conditions and arrangement of the various exemplary embodiments without departing from the scope of the present disclosure.

What is claimed is:

1. A battery module comprising:
a housing comprising a central plenum; and
a plurality of cells provided within the housing, the plurality of cells comprising a first group of the plurality of cells and a second group of the plurality of cells separated from the first group by the central plenum;
wherein the housing is configured to direct cooling air from the central plenum to the plurality of cells; and
wherein each of the first group and the second group is arranged in a first layer of cells and a second layer of cells offset relative to the first layer of cells.

2. The battery module of claim 1, further comprising:
a plurality of cell plenums, each of the plurality of cell plenums being associated with one of the plurality of cells;
wherein each of the plurality of cell plenums is configured to direct the cooling air from the central plenum to the associated cell.

3. The battery module of claim 2, wherein the housing comprises a first tray, a second tray, and a third tray, wherein the first layer is provided between the first tray and the second tray and the second layer is provided between the second tray and the third tray.

4. The battery module of claim 3, wherein each of the plurality of cell plenums is formed by two of the first tray, the second tray, and the third tray.

5. The battery module of claim 4, wherein each of the plurality of cell plenums is at least partially formed by the spaces between adjacent cells formed by the second layer of cells being offset relative to the first layer of cells.

6. The battery module of claim 4, wherein the first tray and the third tray each comprise a plurality of apertures configured to permit the cooling air to exhaust from the plurality of cell plenums.

7. The battery module of claim 6, wherein the plurality of cell plenums are configured to direct cooling air over the plurality of cells in a direction generally transverse to the longitudinal axes of the plurality of cells.

8. The battery module of claim 2, wherein each of the plurality of cell plenums comprises an inner surface having at least one projection configured to maintain a plenum space between the associated cell and the inner surface of the cell plenum.

9. The battery module of claim 1, wherein each of the plurality of cells comprises two terminals that extend at least partially outside the housing.

10. The battery module of claim 9, wherein the housing comprises a plurality of openings through which the two terminals of each of the plurality of cells extend.

11. The battery module of claim 9, wherein the two terminals of each of the plurality of cells are positioned such that any electrical connections to the two terminals may be made external to the housing.

12. A battery module comprising:
a housing; and
a plurality of electrochemical cells provided within the housing, the plurality of cells comprising a first group of cells and a second group of cells, wherein the first group and the second group each comprise a first layer of cells and a second layer of cells, with the second layer of cells offset relative to the first layer of cells;
wherein the housing includes a space between the first group and the second group for routing cooling air and the housing is configured to direct cooling air from the space to the plurality of cells.

13. The battery module of claim 12, wherein each of the plurality of electrochemical cells have a generally cylindrical shape.

14. The battery module of claim 12, wherein the housing comprises a plurality of trays configured to physically separate the plurality of electrochemical cells from each other and to form cooling paths around an exterior surface of each of the plurality of electrochemical cells.

15. The battery module of claim 14, wherein the plurality of trays define a plurality of cell plenums, each of the plurality of cell plenums being associated with one of the plurality of cells, wherein each of the plurality of cell plenums is configured to direct the cooling air from the space to an associated cell.

16. The battery module of claim 15, wherein the plurality of cell plenums are configured to direct cooling air over the cells in a direction generally perpendicular to central longitudinal axes of the cells.

17. The battery module of claim 12, wherein each of the cells includes a central longitudinal axis and the cells of the first group and the cells of the second group are arranged such that their central longitudinal axes are generally parallel.

18. The battery module of claim 12, wherein the housing comprises a first tray, a second tray, and a third tray, wherein the second tray is provided between the first tray and the third tray, the first layer is provided between the first tray and the second tray and the second layer is provided between the second tray and the third tray.

19. The battery module of claim 17, wherein the first tray and the third tray each comprise a plurality of apertures configured to permit the cooling air to exhaust from the plurality of cell plenums.

20. The battery module of claim 12, wherein each of the cells includes two terminals that extend at least partially outside the housing.

21. The battery module of claim 20, wherein the housing comprises openings through which the two terminals of each of the plurality of cells extend.

22. A battery module comprising:
a housing comprising a first member and a second member that are arranged to define a central plenum;
a third member provided between the first member and the second member, wherein the first member, the second member, and the third member are arranged to define a plurality of cell plenums in communication with the central plenum; and
wherein the plurality of cell plenums comprises a first group of cell plenums separated from a second group of cell plenums by the central plenum; and
wherein each of the first group of cell plenums and the second group of cell plenums comprises a first layer of cell plenums and a second set of cell plenums offset relative to the first layer of cell plenums.

23. The battery module of claim 22, wherein each of the first member and the second member comprises a plurality of apertures configured to permit cooling air to exit the housing from the plurality of cell plenums.

24. The battery module of claim 23, further comprising:
a plurality of cells provided within the housing, each of the plurality of cells being associated with a single one of the plurality of cell plenums,
wherein the housing comprises a plurality of ribs configured to provide a space between each of the plurality of cells and the housing.

25. The battery module of claim 24, wherein the first member, the second member, and the third member are configured to direct cooling air around each of the plurality of cells in a direction generally perpendicular to central longitudinal axes of the cells.

26. The battery module of claim 24, wherein the plurality of cells each are generally cylindrical.

27. The battery module of claim 24, wherein the second member comprises a first portion and a second portion separated by the central plenum.

28. The battery module of claim 24, wherein the plurality of cells each comprise at least one terminal extending to the exterior of the housing such that electrical connections to the plurality of cells may be made exterior to the housing.

29. The battery module of claim 24, wherein the cells are lithium-ion cells.
